(19) United States
(12) Patent Application Publication
(10) Pub. No.: US 2006/0216596 A1
(43) Pub. Date: Sep. 28, 2006

(54) PTFE copolymer and binding for coating cathode particles

(76) Inventor: Michael Cheiky, Thousand Oaks, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/089,998

(22) Filed: Mar. 25, 2005

(51) Int. Cl. H01M 4/62; H01M 4/50; H01M 4/52; H01M 4/58; H01M 4/04

(52) U.S. Cl. 429/217; 429/232; 429/231.3; 429/221; 429/231.8; 429/223; 429/220; 429/231.7; 429/224

(57) ABSTRACT

An improved cathode film is formed by forming a copolymer of 10 to 90 mol percent of a fluorinated ethylene copolymer such as tetrafluoroethylene soluble in an organic solvent such as acetone. An ionically conductive salt such as potassium trifluorosulfonate is added to a solution of the copolymer. The solution is applied to particles of active cathode material such as AgO. The solvent is removed to form a film which can be pressed onto a current collector.

### TECHNICAL FIELD

This invention relates to binders for cathodes for batteries and fuel cells.

### BACKGROUND OF THE INVENTION

Binders have traditionally been used to isolate electrode particles which prevents them from fusing. Binders perform this function by acting as a mechanical barrier between electrode particles. At the same time, a binder provides ease of processing for the battery electrode composite by introducing mechanical cohesion between the electrode particles themselves and between electrode particles and the current collector of the battery. Binders are typically insoluble in the materials present in the battery or fuel cell. They are made of materials which are inert during typical device operating voltages.

A trend in consumer electronics is that mobile electronic devices require longer run times and higher capacity energy storage devices. These demands are being met by better performing batteries. Current development is also ongoing in the fuel cell industry to meet these demands. Both batteries and fuel cells rely on binders to provide structural integrity to the cathode. The increasing use of nanoparticles in power sources makes it imperative that a proper readjustment of cathode binders be made in order to extract better performance.

Water-insoluble fluorinated resin powders such as polytetrafluoroethylene (PTFE, such as Dupont Teflon®), and polyvinylidene fluoride (PVDF, such as Arkema Kynar®) have found wide acceptance in electrochemical power sources as binders of choice. The former can be obtained as a 60% aqueous dispersion of PTFE spheres. These spheres can range in size from less than 1 micron to several hundred microns. They have found particularly wide applicability in lithium secondary battery systems.

### DESCRIPTION OF THE PRIOR ART

For example, U.S. Pat. Nos. 6,120,565 and 6,114,061 by Dix et al describes a method for making a cathode, wherein the cathode utilizes a polymeric binder consisting of PTFE and a compound selected from the group consisting of PVDF, copolymers of vinylidene fluoride and hexafluoropropylene, and mixtures thereof. This patent uses bulk PTFE in combination with other compounds as the polymeric binder. A polymeric matrix comprising a copolymer of vinylidene fluoride and hexafluoropropylene (VdF:HFP) was disclosed by Bell Communications Research as disclosed in U.S. Pat. Nos. 5,418,091 and 5,460,904.

Polyhexafluoropropylene and fluorinated ethylene-propylene copolymers (FEP) have also been used as binders. Additionally, JP-A-4-95363 discloses a polymeric binder comprised of vinylidene fluoride-trifluorochloroethylene copolymer (PVDF-PCTFE). The proportion of trifluorochloroethylene in the copolymer is greater than 15 wt % in order to make the resulting copolymer sufficiently elastic. Fluorinated polyimide is disclosed as a binder in US Patent Application 20030049535.

Nonfluorinated binders. including polyethylene, polypropylene, ethylene-propylene copolymer or ethylene-propylene-diene (EPDM) rubbers (such as ExxonMobil Vistalon®), polyisobutylene (e.g. ExxonMobil Vistanex®), polyethylene oxide (PEO), polystyrene and the like have been incorporated in various binder systems. Thermoplastic polymers, such as polymethyl acrylates, polymethyl methacrylates, polyacrylonitriles and polyvinylpyrrolidones, as well as inorganic cements such as Portland cement and Plaster of Paris have been used as binder polymers for electrodes.

All the above binders are typically mixed in with electrode materials in a slurry form and dried under various conditions. In this manner a cake is prepared that can be compressed at high pressure. The interface between the binder and the electrode particles in principle should provide sufficient space for pores within the resulting cathode structure. The size of these pores and hydrophobicity of the isolating material is critical in determining electrolyte accessibility to the electrode materials and thus, ultimately, optimal battery performance. Using commonly available PTFE particles and cathode nanoparticles, a severe mismatch exists between the binder particle size and the electrode particle size. This mismatch can also contribute to increased electrolyte resistance and overall cell resistance. Additionally, there are difficulties in attaining desired viscosity and moldability in cathodes that utilize bulk PTFE.

### STATEMENT OF THE INVENTION

The present invention overcomes these limitations by eliminating the insoluble bulk binder particles. In the invention a mixture of an ionically conductive salt and a soluble PTFE-based copolymer is used to effectively bind isolated cathode nanoparticles while resisting oxidation in electrochemical environments. This binder mixture is overall less hydrophobic and more ionically conductive than bulk PTFE, while providing greater ease of processing.

In the present invention, the polymeric binder is comprised of a copolymer dissolved in solvent and an ionically conductive salt dispersed in said polymeric binder. The binder material coats the cathode material evenly on a molecular level. This binder provides improved ionic conduction, mechanical cohesion as well as chemical resistance. The binder is applied to the cathode particles via a variety of well-known techniques.

The polymeric binder is a copolymer of 10 to 90 mol percent fluoroethylene the remainder being a vinyl or olefin polymer or fluorinated or oxygenated derivates thereof. The copolymer can be a random copolymer but preferable is a block or graft polymer containing side by side and/or end to end blocks of polytetratluoroethylene and of polymer segment providing solubility and elastomeric properties to the copolymer. The copolymer can be comprised of PTFE and at least one of the following materials: polyvinylidenefluoride, fluororubbers, polyolefins, particularly polyethylene and polypropylene or their fluorinated counterparts, polyethylene oxide, polybutadiene, and polyisoprene. PTFE may also be copolymerized, solely or in combination with the above materials, with perfluoro(methyl vinyl ether), perfluoro(propyl vinyl ether), or perfluoro(2,2-dimethyl-1,3-dioxole. Additionally, the following may serve as copolymers: styrene-1,3-butadiene copolymer, styrene-isoprene copolymer, styrene-1,3-butadiene-isoprene copolymer, 1,3-butadiene-acrylonitrile copolymer, 1,3-butadiene-isoprene-acrylonitrile copolymer, styrene-acrylonitrile-1,2-butadiene copolymer, styrene-acrylonitrile-1,3-butadiene-itaconic acid copolymer, styrene-acrylonitrile-1,3-butadiene-methylmethacrylate-fumaric acid copolymer, styrene-1,3-butadiene-itaconic acid, polymethylmethacrylate-acrylonitrile copolymer, and polystyrene-polybutadiene block copolymer.

The copolymer portion of the present invention may also comprise oxygenated versions of the copolymers such as for example, poly(tetrafluoroethylene oxide-co-difluoromethylene oxide).

The percent mole composition of the PTFE moiety in the copolymer may range from 10% to 90%. The molecular weights of the polymeric units of the copolymer are without limitation, but considerations in the copolymer synthesis may provide practical constraints. The polymeric units may be arranged in an alternating or random block fashion.

The ionically conductive salt may comprise any of the materials known to those skilled in the art, including salts of sulfonates, carboxylates and hydroxyls. Preferred embodiments include perfluorinated sulfonates disclosed in co-pending application Ser. No. 10/845,110. The percent composition of the ionially conductive salt can vary from 1% to 50% of the weight of the PTFE copolymer.

The coating of the polymeric binder of the present invention may be applied to numerous cathode materials. In particular, the coating may be applied to AgO, MnO2, LiCoOx, FeOx, NIOOH, graphite monofluoride, CuS or mixtures thereof. Various other positive active cathode materials will readily occur to one skilled in the art. The cathode materials should exhibit chemical compatibility with the solvent that solubilizes the copolymer. The solvent should not discharge the active material significantly in the time it takes to coat the polymer binder on the cathode material. Acetone and lower boiling ketones such as methyl ethylketone have been found to be particularly useful as solvents that meet these criteria.

The copolymer also need not be entirely soluble in the solvent; a few percent solubility should suffice in coating the binder.

The percentage of polymeric binder can comprise from 0.1% to 25%, and preferably 1% to 10%, of the entire weight of electrode. Excessive amount of binder detracts from the gravimetric density of the battery while too little provides no mechanical cohesion.

Additional conductivity enhancing agents such as 0.1 to 5 percent by weight of carbonaceous powders as well as 0.1 to 3 percent by weight of surfactants may optionally be added to the binder. Thickeners, such as water soluble polymers such as methylcellulose and carboxymethylcellulose, may also be included. A mixture of two or more polymeric binders may be used as well. Numerous combinations of the above may occur to those skilled in the art of electrode fabrication.

Different deposition methods may be used such as uniform spraying, painting, and dipping. The mixture comprising the polymer binder may also be precipitated from solution by chemical or laser methods. The cathode materials which incorporate the polymeric binder and electrode powder may be ball milled and pressed together. The cathode may be compressed at high pressures after binder deposition, typically from 500 psi to 10000 psi as in the case for bulk PTFE.

### ILLUSTRATVIE EXAMPLES

The following are illustrative examples of the present invention:

1) A 25% solution of copolymer of composition Poly(tetrafluoroethylene-co-vinylidene fluoride-co-propylene) (Aldrich 45,458-3) in acetone is made. 1.0 g of potassium trifluorosulfonate is added to 2 ml of this solution. The resulting suspension is mixed with 10.0 g of AgO active cathode material. The acetone evaporates quickly. The AgO and polymer binder are pressed at 10,000 psi to generate a cathode ready to be used.

2) A perfluoroelastomer copolymer derived from a modified structure of tetrafluoroethylene and propylene copolymers (Fluoraz®, Greene, Tweed, Inc) is partially solubilized in methyl ethyl ketone. The insoluble portions are filtered. 90 parts Fluoraz and 10 parts potassium hydroxide are then sprayed on a cathode of MnO₂ to produce a total 2% coating on the cathode. The methyl ethyl ketone is evaporated at room temperature. Carboxymethylcellulose is added to the coated MnO₂. The cathode material is pressed to a pressure of 2,000 psi.

It is to be realized that only preferred embodiments of the invention have been described and that numerous substitutions, modifications and alterations are permissible without departing from the spirit and scope of the invention as defined in the following claims.

1. An electrode film containing a dispersion of electrode particles comprising in combination:
a film of a mixture of a copolymer and an ionically conductive salt, said copolymer soluble in organic solvent and containing at least 10 mol percent of a fluorinated ethylene polymer, the remainder being a second polymer providing solubility in an organic solvent, said soluble copolymer coating and binding particles of cathode material to form said film.

2. An electrode film according to claim 1 supported on a current collector.

3. An electrode film according to claim 1 in which the fluorinated ethylene polymer is tetrafluoroethylene.

4. An electrode film according to claim 3 in which the ionicaly conductive salt is present in an amount from 1 percent to 50% by weight of said copolymer.

5. An electrode film according to claim 4 in which the ionically conductive salt is selected from the group consisting of sulfonates, carboxylates, hydroxyls and perfluorinated sulfonates.

6. An electrode film according to claim 4 in which the copolymer comprises from 1.0 percent to 25 percent by weight of the film.

7. An electrode film according to claim 1 in which the electrode is a cathode and the cathode material is selected from at least one of the groups consisting of AgO, MnO₂, LiCoOₓ, FeOₓ, NiOOH, graphite monofluoride and CuS.

8. An electrode film according to claim 1 in which the copolymer is soluble in a ketone solvent.

9. An electrode film according to claim 1 in which the soluble copolymer contains 10 mol percent to 90 mol percent of a fluorinated ethylene polymer and the remainder being a second polymer selected from vinyl or olefin polymers and fluorinated or oxygenated derivations thereof.

10. An electrode film according to claim 9 in which the second polymer is selected from the group consisting of: polyvinylidenefluoride, fluororubbers, polyolefins, polyethylene oxide, polybutadiene, and polyisoprene, PTFE copolymerized with at least one of the above polymers, with perfluoro(methyl vinyl ether), perfluoro(propyl vinyl ether), or perfluoro(2,2-dimethyl-1,3-dioxole, styrene-1,3-butadiene copolymer, styrene-isoprene copolymer, styrene-1,3-butadiene-isoprene copolymer, 1,3-butadiene-acrylonitrile copolymer, 1,3- butadiene-isoprene-acrylonitrile copolymer, styrene-acrylonitrile-1,2-butadiene copolymer, styrene-acrylonitrile-1,3-butadiene-itaconic acid copolymer, styrene-acrylonitrile-1,3-butadiene-methylmethacrylate-fumaric acid copolymer, styrene-1,3-butadiene-itaconic acid, polymethylmethacrylate-acrylonitrile copolymer, polystyrene-polybutadiene block copolymer and poly(tetrafluoroethylene oxide-co-difluoromethylene oxide).

11. An electrode film according to claim 10 in which the polyolefin is selected from the group consisting of polyethylene, polypropylene, polyethylene oxide, polybutadiene, polyisoprene and fluoro-containing derivatives thereof.

12. An electrode film according to claim 1 in which the copolymer is Poly(tetrafluoroethylene-co-vinylidene fluoride-co-propylene).

13. An electrode film according to claim 1 in which the copolymer is tetrafluoro-ethylene-propylene copolymer.

14. A method of forming an electrode comprising the steps of:
dissolving a copolymer of fluorinated ethylene and an ionically conductive salt in organic solvent to form a suspension;
adding active electrode material to the suspension;
removing the solvent to form a cake; and
pressing the cake to form an electrode film.

15. A method according to claim 14 in which the electrode material is finely divided cathode particles.
